(19) United States
(12) Patent Application Publication
(10) Pub. No.: US 2026/0365587 A1
(43) Pub. Date: Nov. 19, 2026

(54) METHOD AND DEVICE FOR PRODUCING A PRINTED CONCRETE BODY, AND PRINTED CONCRETE BODY

(71) Applicant: Baustoffwerke Gebhart & Soehne GmbH & Co. KG, Lachen (DE)

(72) Inventor: Hans GEBHART, Lachen (DE)

(21) Appl. No.: 19/121,833

(22) PCT Filed: Oct. 18, 2023
(86) PCT No.: PCT/EP2023/079055

§ 371 Date: Apr. 17, 2025

(30) Foreign Application Priority Data
Oct. 19, 2022 (DE) 10 2022 127 578.7

(51) Int. Cl. C04B 41/45; B28B 1/00; B28B 11/04; C04B 41/00; C04B 41/48; C04B 41/52; C04B 41/63; C04B 41/71; C09D 11/107; C09D 11/30; C09D 11/54; E04C 1/00; E04C 2/04; E04F 11/116

(52) U.S. Cl. CPC C04B 41/4578; B28B 1/005; B28B 11/048; C04B 41/009; C04B 41/4543; C04B 41/4572; C04B 41/483; C04B 41/52; C04B 41/63; C04B 41/71; C09D 11/107; C09D 11/30; C09D 11/54; E04C 1/00; E04C 2/044; E04F 11/116

(57) ABSTRACT

The invention relates to a method for producing a printed concrete body (1), in particular a printed concrete block, a printed concrete panel or a printed concrete step, comprising at least the following steps:-printing at least one visible face (2) of the concrete body (1); and -curing the concrete body (1) after the printing process. According to the invention, 5% to 90% of the visible face (2) of the concrete body (1) is printed such that the visible face (2) has a pattern, by means of which the visible face (2) of the concrete body (1) obtains a natural stone appearance, a wood appearance, a textile appearance, a tile appearance or a mosaic appearance.

The present application claims the priority of German patent application No. 10 2022 127 578.7, the content of which is fully incorporated herein by reference.

The invention relates to a method for producing a printed concrete element, more particularly a printed concrete block, a printed concrete slab or a printed concrete step according to the preamble of claim 1.

The invention further relates to a device for producing a printed concrete element as claimed in claim 17.

The invention additionally relates to a printed concrete element.

The printing of concrete elements, more particularly of concrete blocks, has emerged as being suitable for imparting a design coloration to the concrete element. In particular there is a need to design a visible face of the concrete element in such a way that it is similar to a natural stone or imitates the visible face of a natural stone. In the printing of concrete blocks, however, there are a large number of challenges to be taken into account, such as, for example, the difficulty of achieving good adhesion of the printing on the concrete.

The known methods for printing concrete elements are based in particular on the so-called dry printing method. With this method, after the concrete has cured, the concrete element is printed in order to apply a pattern to the visible face or to give said face a design coloration.

It has been found that the printing of uncured, wet concrete may be of particular advantage since the printing compositions used for printing may, as a result of diffluence in the concrete, result in patterns and structures which cannot be obtained by the dry printing method. However, the printing compositions used for this purpose must be selected such that they have good adhesion to the concrete element to be subsequently cured and are compatible with the conditions of curing of the concrete element.

A method of the generic type is known from DE 10 2017 005 280B4 .

DE 10 2017 005 280 B4 proposes a method for producing a printable concrete element in which provision is made to introduce a concrete into a mold, to shape a concrete element. Provision is subsequently made to print a visible face of the concrete element with a printing composition comprising a binder A and a dye B, wherein the binder A is to comprise at least one siloxane and a silane, and wherein the siloxane is to be a condensed, pre-crosslinked silicone resin. After printing, curing of the concrete element is provided.

For the further prior art, reference is also made to DE 10 2006 014 900A1 .

DE 10 2006 014 900 A1 describes a wet printing method for concrete elements. The concrete product described therein has printing incorporated into the concrete at a visible face. The printing is performed in terms of production on the wet concrete which has not yet set or has at most partially set. DE 10 2006 014 900 A1 discusses neither a printing composition nor the diffluence of the printing composition on the wet concrete. DE 10 2006 014 900 A1 thus does not disclose how diffluent patterns can be achieved on and/or in the concrete. In addition, the document does not address the problem of the adhesion of the material on the cured concrete and the properties the printing composition must have so that the printing composition does not lose the desired structure on thermal curing of the concrete element.

Proceeding from the prior art, it would be desirable to provide a method and a device for printing concrete elements with which it is possible in a simple, reliable and cost-effective manner to permanently impart an aesthetic design to a visible face of a concrete element. In this context it would also be desirable for the method and the device to be able to be integrated into the existing plant concepts, including in particular in existing plants for producing concrete elements. The methods known from the prior art, as for example DE 10 2017 005 280B4 , usually envisage the use of a so-called primer, which is applied to the visible face of the concrete element and provides a white surface which can then be printed. Although a good printed image can be produced with the aid of the white surface provided by the primer, and colors can be advantageously represented in particular, there is the disadvantage that in the event of manual damage to the visible face, the white primer underneath the printing becomes clearly visible, as a result of which the appearance of the concrete element is durably impaired.

The present invention is based on the object of providing a method for producing a printed concrete element with which a visible face of the concrete element can be printed in a particularly advantageous manner in order to give the concrete element an aesthetic appearance in a cost-effective manner and durably.

This object is achieved according to the invention through the features of claim 1.

The present invention is further based on the object of providing a device for producing a printed concrete element with which a visible face of the concrete element can be printed in a particularly advantageous manner in order to give the concrete element an aesthetic appearance in a cost-effective manner and durably.

This object is achieved according to the invention through the features of claim 17.

The present invention is further based on the object of providing a printed concrete element which has an aesthetically pleasing and cost-effectively producible visible face which is resistant to weather conditions.

This object is achieved according to the invention through claims 18 and 19.

The method according to the invention for producing a printed concrete element, more particularly a printed concrete block, a printed concrete slab or a printed concrete step, comprises at least the following steps:
printing at least one visible face of the concrete element; and
curing the concrete element after printing.

According to the invention, it may be the case that 5% to 90% of the visible face of the concrete element is printed in such a way that the visible face has a pattern through which the visible face of the concrete element acquires a natural stone, wood, textile, tile or mosaic appearance.

It has been found that printing of only 5% to 90% of the visible face of the concrete element is particularly advantageous in order to give the visible face of the concrete element overall a natural stone, wood, textile, tile or mosaic appearance. In a departure from the teaching from the prior art, in which provision is made for printing the entire visible face of the concrete element, it has been found that the printing of only a part of the visible face makes it possible to achieve an appearance which is closer to that of a natural stone, a wood, a textile, a tile or a mosaic than printing of the entire visible face. Because only a part of the visible face is printed, the device used for the printing, in particular a printer and in particular also its nozzles, is also less stressed. Furthermore, the consumption of an ink or of a printing composition falls.

Generally, in the case of a concrete element, for example in the case of a paving block, only one side of the concrete element will form the visible face in the installed state. In this case, it is sufficient if only the side of the concrete element, generally the top side of the concrete element, that forms the visible face is printed. Where the concrete element is embodied as a concrete step, provision may be made for the concrete element to have two visible faces, which preferably run at an angle of 90° to one another and which are a top side and a side wall of the concrete element. In this case, preferably both visible faces, i.e. the top side and the side wall, of the concrete element can be printed according to the invention. However, it is also possible in this case for only one visible face, for example the top side or the side wall, of the concrete element to be printed.

When the concrete element is embodied as a wall block or masonry block, provision may also be made for the concrete element to have more than only one visible face, for example two visible faces which are opposite side walls which run preferably plane-parallel to one another. A concrete element in the form of a masonry block may, moreover, also have visible faces on the end-side (short) side walls and/or on the top side. Provision may be made here for the concrete element to be printed according to the invention on two, three or else on four sides/walls. However, provision may also be made for only some of the visible faces to be printed, for example if only one side of a free-standing wall is intended to receive a natural stone appearance.

It is advantageous if 5% to 80%, preferably 10% to 80%, more preferably 20% to 70%, particularly preferably 30% to 70%, of the visible face of the concrete element is printed.

The aforementioned values have emerged as being particularly suitable for printing of the visible face.

According to the invention, provision may further be made for the visible face of the concrete element to be printed with at least one, preferably two or more, crack lines, more particularly crack lines having a marble appearance, and/or structure lines and/or notches and/or speckles and/or spots and/or shades.

It has emerged as being particularly suitable for producing a natural stone, wood, textile, tile or mosaic appearance if the visible face is printed with crack lines, more particularly crack lines having a marble appearance, and/or structure lines, in particular in different lengths and with different profiles, and/or notches, in particular with different thicknesses and/or differently colored designs. Preferably, the crack lines, the structure lines, the notches, the speckles, the spots and the shades are printed irregularly on the visible face of the concrete element or distributed irregularly over the visible face.

It may be sufficient if 10% to 20% of the visible face is printed with crack lines and/or structure lines and/or notches and/or speckles and/or spots in order to achieve a natural stone appearance or a mosaic appearance, in particular in conjunction with a visible face colored prior to printing. In this regard, reference is also made to the configurations below.

According to the invention, it may be the case that at least one region of the visible face of the concrete element, preferably the entire visible face of the concrete element, is colored prior to printing.

Surprisingly it has been found that, owing to the fact that at least one region of the visible face of the concrete element, preferably the entire visible face of the concrete element that is to be printed according to the invention, is colored prior to printing, a particularly advantageous natural stone, wood, textile, tile or mosaic appearance can be achieved without full-area printing being necessary. The coloring here is preferably achieved by virtue of the concrete which forms the visible face being colored. The coloring can preferably be carried out with a gray, a light gray, a beige, a light blue, a blue, a green, a black, a white, a brown, a red or a yellow hue. Preferably, the visible face of the concrete element is colored in such a way that it has a marble appearance and/or an irregular color profile and/or an irregular structuring and/or an irregular color strength and/or shades and/or lighter and darker regions.

Provision may be made for only the visible face or two or more visible faces of the concrete element to be correspondingly colored, preferably down to a depth orthogonal to the visible face of 2 mm to 30 mm. In particular, provision may be made for only the facing concrete to be colored in the case of a concrete element which is formed of a core concrete and a facing concrete. In this case, the facing concrete generally forms the top side or the visible face of the concrete element, for example of a paving block or a concrete slab.

According to the invention, provision may further be made for the visible face of the concrete element prior to printing to acquire a marbling appearance and/or a structuring and/or a multi-colored design by virtue of the concrete used for producing the concrete element, and/or for a color and/or aggregates, more particularly fine-grained aggregates, to be added to the concrete used for producing the concrete element.

It may be advantageous if, as already expounded above, only the concrete forming the visible face of the concrete element, for example a facing concrete, is designed in such a way as to produce a marbling appearance and/or a structuring and/or a multi-colored design. The facing concrete may also, additionally or alternatively, comprise aggregates, more particularly fine-grained aggregates of granite or basalt, and/or a color may have been admixed to the concrete.

According to the invention, provision may further be made for the method to comprise the following steps:
filling a colored concrete and/or a mixture of different-colored concrete into an infilling mold for shaping the concrete element, or
filling a concrete into an infilling mold for shaping a main body of the concrete element and filling a colored concrete and/or a mixture of different-colored concrete into the infilling mold for shaping the visible face of the concrete element, wherein the concrete forming the main body of the concrete element differs in color from the concrete and/or the mixture of different-colored concrete which forms the visible face of the concrete element.

It has been found that a suitable design of the visible face or faces of the concrete element can be achieved by filling a colored concrete and/or a mixture of different types of concrete into an infilling mold for shaping the concrete element.

A particularly advantageous method for achieving colorization of the concrete element is known from EP 2 237 937B1. By means of the device disclosed therein and the method, it is possible in a particularly advantageous manner to form a multi-colored concrete element, in particular also with a marbling appearance.

Provision may be made for the entire concrete element to be made available by filling a colored concrete and/or a mixture of different types of concrete into an infilling mold.

Alternatively, however, it may also be the case that a conventional concrete, in particular a non-colored concrete, in particular a core concrete, is filled into an infilling mold for forming a main body of the concrete element and that only the region of the concrete element that forms the visible face of the concrete element is colored. A facing concrete is preferably used for producing the visible face. The colored concrete and/or a mixture of different types of concrete by means of which the visible face is formed, or the facing concrete, is preferably filled into the infilling mold in which the core concrete is already located.

The concrete which forms the main body of the concrete element here differs in color from the concrete and/or from the mixture of different types of concrete which forms the visible face of the concrete element, i.e. the facing concrete.

It is typically envisaged that first the concrete forming the main body of the concrete element, the so-called core concrete, is introduced into the infilling mold and then the concrete forming the visible face, in particular the facing concrete, is added. In this case, provision may be made for vibration and/or compaction to take place after the core concrete has been introduced, for which purpose a ram can be used. However, in order to produce the concrete element, it may also be the case that first the facing concrete is introduced into the infilling mold and then the core concrete is added in order to form the main body of the concrete element. Furthermore, provision may also be made for firstly the facing concrete, then the core concrete and then again the or a further facing concrete to be introduced into the infilling mold, in particular in order to form two visible faces.

When both the facing concrete and the core concrete have been introduced into the infilling mold, irrespective of the sequence, vibration and/or compaction take place in a known manner.

A formation of the concrete element in such a way that it has a main body made of an uncolored concrete, in particular a core concrete, and only the concrete which forms the visible face or the visible faces of the concrete element, in particular a facing concrete, is colored and/or said concrete is produced from a mixture of different-colored concrete, has emerged as being particularly advantageous since the uncolored concrete, in particular the core concrete, is available under more favorable terms. Impairments in the formation of the visible face arising from the fact that only the visible face is provided by a colored concrete prior to printing are not anticipated despite the use of uncolored core concrete.

It is advantageous if the colored concrete forming the visible face or faces and/or the mixture of different-colored concrete, in particular the facing concrete, has a thickness of at least 5 mm and preferably of at most 50 mm, particularly preferably at most 30 mm. It is particularly advantageous if at most 30%, particularly preferably at most 20%, more particularly at most 15%, of the volume of the concrete element is formed by the colored concrete and/or the mixture of different-colored concrete.

It may be provided within the scope of the invention that a fine-grained aggregate, composed for example of granite or basalt, is added to the concrete in order to achieve a structuring and/or a colored appearance of the concrete.

According to the invention, provision may further be made for the printing of the concrete element to be carried out in a green-strength state of the concrete element, in which the concrete element is dimensionally stable but not yet cured.

It has emerged as being particularly suitable if a concrete element in a green-strength state is printed in accordance with the invention.

A green-strength concrete element is understood to be a concrete element which is dimensionally stable but not yet cured or not yet completely set. In particular, it is understood to be a concrete element which has not yet been introduced into a setting space or into a setting chamber/drying space in order to cure completely there.

A green-strength concrete element is understood in particular to be a concrete element in which the main compaction process has concluded, but which has not yet set.

A concrete element in the green-strength state is also referred to in the prior art as a “green” concrete blank. The green-strength state of the concrete element means that the concrete element has already cured to such an extent that it retains its shape if the concrete element leaves the production mold or the infilling mold or if the concrete element were to be removed from the mold.

The printing on the visible face of the concrete element thus takes place in a state in which the visible face of the concrete element is still moist or wet.

It has been found that the printing of the concrete element in a green-strength state is particularly advantageous since the printing composition or the ink used for the printing penetrates well or far into the concrete and flows away. Although this can lead to exact structures not being able to be printed in the same sharpness possible in the case of a dry printing method, it has nevertheless emerged as being advantageous, for producing a natural stone appearance, a wood appearance, a textile appearance, a tile appearance or a mosaic appearance, if the ink or the printing composition runs to some extent in the horizontal and/or vertical direction, i.e. in the plane of the visible face (=horizontal) and orthogonally (=vertical) thereto.

It has been found that the printing of a concrete element in a green-strength state makes it possible to achieve printing which is also resistant to weather conditions, in particular because the printing or the ink/printing composition is able to penetrate comparatively deeply into the concrete of the concrete element.

According to the invention, provision may further be made for the concrete element to be printed while the concrete element is still in an infilling mold in which the concrete element is compacted, or the concrete element to be printed after the concrete element has left an infilling mold in which the concrete element is compacted.

It has emerged as being particularly advantageous if the concrete element is printed after the concrete element has left an infilling mold in which the concrete element is compacted. In this case, the element is a green-strength concrete element or a freshly manufactured and already deshuttered concrete element. However, the concrete element has not yet set or is not yet situated in the setting region or the setting chamber. In this state, the concrete element can be printed in a particularly suitable manner technically and economically.

Alternatively to this, however, it is also possible to print the concrete element while the concrete element is still in an infilling mold in which the concrete element is compacted. The concrete element has already been compacted here, and the concrete element is thus in a green-strength state, but is still in the production mold or the infilling moid. It may be suitable, in particular for specific applications, for the visible face of the concrete element to be printed in this state of the concrete element.

One advantage here may be that the printing can take place particularly exactly, since the position of the concrete element in the production mold or the infilling mold is exactly predefined.

It is advantageous, however, if the printing of the visible face takes place in a state of the concrete element in which the latter is already dimensionally stable—i.e. after conclusion of the main compaction process-but has not yet completely set. Here, preferably, the concrete element is no longer in the production mold or the infilling mold in which it has been compacted.

According to the invention, provision may further be made for the method to comprise the following step:
applying, preferably spraying, at least one coating, preferably composed of an acrylate dispersion, to the printed visible face of the concrete element before curing.

It has emerged as being particularly advantageous if, before the curing of the concrete element, in particular the curing of the green-strength concrete element, a coating is applied to the printed visible face of the concrete element. Spraying application of the coating has emerged as being particularly advantageous here. It has emerged as being particularly advantageous to use an acrylate dispersion as a coating. Surprisingly it has been found that particularly good bonding of the printed ink or of the printing composition to the concrete can be achieved if a coating, in particular an acrylate dispersion, is applied after the printing but before the curing. The inventor has recognized that a cement paste which can form at the visible face of the concrete element as a result of the compaction process during production of the concrete element is disadvantageous for the printing and the disadvantage can be overcome by applying a coating, in particular an acrylate dispersion as a coating, to the visible face of the concrete element after the printing.

According to the invention, provision may further be made for the method to comprise the following step:
applying, preferably spraying, at least one coating, preferably a UV coating, more particularly a varnish, to the printed and cured visible face of the concrete element.

It has emerged as being particularly suitable if a coating is applied, preferably by spraying, to the printed and cured visible face of the concrete element, i.e. after the concrete element has cured. Provision may also be made here for more than one coating to be applied to the visible face of the concrete element after curing. The coating or one of the coatings may preferably be a so-called UV coating or a UV-curing coating, i.e. a coating which can be cured by UV radiation. The coating may in particular be a varnish, in particular a UV varnish.

In the context of the invention, it has emerged as being particularly suitable for protecting the printing if, after the printing but before the curing, a first coating, preferably composed of an acrylate dispersion, is applied and if, after the curing of the visible face, in particular when the concrete element has left a setting region or a setting chamber/a drying space again, at least one further coating, preferably a UV coating, in particular a varnish, more preferably a UV varnish, is applied. As a result, a particularly good and durable natural stone, wood, textile, tile or mosaic appearance can be generated and also maintained under harsh weather conditions, with clouding also being very largely avoided.

It is advantageous if the printing takes place with a printing composition, substantially consisting of chromophoric inorganic pigments and a solvent, preferably a binder-free solvent, or a solvent mixture, preferably a binder-free solvent mixture.

Surprisingly it has been found that a printing composition substantially consisting of chromophoric inorganic pigments and a binder-free solvent or a binder-free solvent mixture is particularly suitable for printing the visible face of the concrete element.

The chromophoric pigments may in particular be iron oxide pigments (red, yellow, black), cobalt oxide pigments (blue, green) and/or titanium oxide pigments (white).

In contrast to the teaching from DE 10 2017 005 280B4 , which explicitly recommends the use of a binder, where the binder is to comprise a siloxane and a silane, it has been emerged that particularly good printing results can be achieved without the use of a binder or by the use of a binder-free solvent or a binder-free solvent mixture, with the printing composition penetrating so deeply into the concrete composition in the horizontal and/or vertical direction that even in the event of damage to the visible face, the applied pattern continues to be recognizable and the desired appearance is therefore retained.

It has also been found that particularly good printing of the visible face of the concrete element can be achieved by chromophoric inorganic pigments.

The solvent or the solvent mixture used with the inorganic pigments may optionally also have a binder, but in this case at least provision is made for the solvent or solvent mixture to be siloxane-free and/or silane-free and/or resin-free, i.e. for the solvent or solvent mixture not to contain any siloxane and/or silane and/or resin.

According to the invention, provision may also be made for the printing to take place with a printing composition, substantially consisting of chromophoric inorganic pigments, polyacrylate as binder and a solvent or a solvent mixture.

Trials have shown that good and permanent printing can also be achieved with a printing composition, substantially consisting of chromophoric inorganic pigments, polyacrylate as binder and a solvent or a solvent mixture. In other words, it has been found that, if a binder is used, polyacrylate is to be used as a binder in order to achieve appropriate or high-quality printing.

It is advantageous if the chromophoric pigments are UV-resistant.

According to the invention, it may be the case that the solvent does not have a water fraction or is not an aqueous system.

The solvent may more particularly be selected from a group consisting of alcohols or esters or special-boiling-point spirits or aromatic solvents.

The solvent mixture consists preferably of water and also alcohols, esters, special-boiling-point spirits, aromatic solvents and mixtures thereof.

According to the invention, it has further emerged as being advantageous if the printing composition consists of 10% to 90% by weight of the solvent and of the chromophoric pigments.

It has emerged as being particularly suitable here if the solvent makes up 50% to 90% by weight, more particularly 60% to 80% by weight, of the printing composition, i.e. if correspondingly the chromophoric pigments make up more preferably 20% to 40% by weight of the printing composition. In particular it may be the case that the printing composition comprises or consists of 70% to 80% by weight of the solvent and correspondingly 20% to 30% by weight of the chromophoric pigments, apart from any unavoidable residual impurities.

According to the invention, if the printing composition comprises a solvent mixture, it may be the case that the solvent mixture has a water fraction of 10% to 90% by weight. It may in particular be the case here that the printing composition consists to an extent of 20% to 40% by weight of the chromophoric pigments and to an extent of 20% to 40% by weight of water, where the water is a constituent of the solvent mixture, and the remaining constituents of the solvent mixture are then formed or selected correspondingly, so that the solvent mixture makes up a total of 60% to 80% by weight of the printing composition.

It may be the case that the printing composition consists to an extent of 20% to 40% by weight of the chromophoric pigments and to an extent of 60% to 80% by weight of the solvent mixture, where the solvent mixture consists to an extent of one third to two thirds % by weight of water.

The inventors have recognized that the following three configurations are particularly suitable for the production of a printing composition.

The printing composition may firstly (first configuration) consist of a solvent with inorganic pigments, where the solvent contains no water or is not an aqueous system and the solvent, preferably a hydro-philic solvent, in the context of the printing composition has a fraction of 10% to 80% by weight, preferably 60% to 90% by weight, and the fraction of the inorganic pigments is chosen correspondingly, being preferably 20% to 40% by weight of the printing composition.

Secondly (second configuration), a printing composition is particularly suitable in which a solvent mixture and inorganic pigments are used. This solvent mixture preferably has a water fraction of 10% to 90% by weight. The fraction of the inorganic pigments in the context of the printing composition may preferably be 20% to 40% by weight, i.e. the solvent mixture is preferably correspondingly 60% to 80% by weight of the printing composition.

As a third printing composition (third configuration), it has emerged as being suitable if the printing composition comprises inorganic pigments and also polyacrylate as binder and a solvent or a solvent mixture. The solvent or the solvent mixture here may be constructed in the same way as set out for the first or the second printing composition (first or second configuration).

According to the invention, it is preferably the case that printing is carried out directly onto the concrete element, more particularly directly onto a green-strength concrete element.

According to the invention, it may in particular be the case that no primer or no adhesion promoter is applied to the visible face prior to printing.

It has been emerged as being particularly advantageous if no primer is applied prior to printing. The prior art teaches that a primer or a priming coat/adhesion promoter is applied prior to printing. The primer in that case is white and allows the printing to be applied particularly well or sharply. However, the inventors have recognized that it is disadvantageous if a primer is applied to the visible face of the concrete element since, in the event of damage to the visible face or in the event of damage to the printing, the underlying white primer becomes clearly visible, as a result of which the appearance of the visible face is durably destroyed. By virtue of the fact that, in the context of the invention, it is preferably envisaged not to use a primer, but rather in particular to print directly onto the concrete element, in particular a green-strength concrete element, the achievement is gained that the printing composition penetrates deeply into the concrete. In the event of damage to the visible face, at least part of the printing or the lower-lying portion of the printing then still remains visible. In particular in conjunction with the fact that it is preferably the case that the concrete itself is already colored or consists of a mixture of different-colored concrete, the desired overall visual impression is maintained even in the event of damage to the visible face.

According to the invention, it may be the case that the printing takes place using an inkjet printing, screen printing, powder coating, laser printing, needle printing, electrostatic printing, liquid printing, digital printing and/or pad printing method.

It has emerged as being particularly suitable if a digital printing method is selected for the printing and the printed image is transferred directly from a file, a data stream or a computer into the printer. Furthermore, the use of an inkjet printing method has emerged as being particularly suitable, since an inkjet printing method can be carried out in an operationally reliable manner even in the rough environment of a block manufacturing plant and is also favorable.

The method according to the invention may also comprise further method steps in addition to the method steps already mentioned. The concrete, after being introduced into the mold, is preferably compacted, in particular by means of vibration and/or by means of a ram. It is preferably the case that the concrete is compacted prior to printing. It is particularly preferable if first a core concrete is introduced, then preferably vibration and ramming take place, and after that the facing concrete is introduced and once again vibration and ramming or the main compaction take place. In the context of the method, it is preferable for the concrete element to be removed from the infilling mold prior to printing. Alternatively, printing may also take place in the mold.

It is possible that, after the printing, the concrete element is subjected to a structure-imparting surface treatment, preferably by brushing and/or embossing and/or grinding and/or shot peening. The structure-imparting surface treatment can be carried out before or after the curing of the concrete element.

The method according to the invention makes it possible to directly print concrete blanks coming from the vibratory press. The printed concrete blanks here can be produced with commercially available vibratory presses and they pass through the printing unit or the printer preferably on the production substrate. The product arrangement according to the mold arrangement can remain unaffected. Subsequently, the concrete blanks, preferably on the production substrate, can be transported into a drying chamber or a drying chamber system for curing. The hydration process binds the pigments deeply into the concrete, in particular the visible face or facing layer or the concrete matrix, and produces a resistant product in the course of curing.

A preferred device for producing a printed concrete element is evident from claim 17.

The present invention also relates to a device for producing a printed concrete element, more particularly a printed concrete block, a printed concrete slab or a printed concrete step, having a reservoir for accommodating a printing composition for printing the concrete element and having a printer for printing at least one visible face of the concrete element, wherein the printer is designed and configured to print a green-strength concrete element in accordance with the method according to the invention.

The printer for use may be any suitable printer, in particular an inkjet printer or a laser printer. A digital printing method is preferably selected as the printing method. It is preferably the case that the device according to the invention is integrated into a plant for producing a concrete element, in particular in such a way that the device forms a station through which the concrete elements pass after the main compaction pass but before the setting region, in particular the setting chamber/drying chamber.

The invention also relates to a printed concrete element as claimed in claim 18.

A particularly advantageous printed concrete element, in particular a printed concrete block, a printed concrete slab or a printed concrete step, is obtainable by the method according to the invention, in particular as claimed in any of claims 1 to 16.

The invention further relates to a printed concrete element as claimed in claim 19.

The present invention also relates to a printed concrete element, more particularly a printed concrete block, a printed concrete slab or a printed concrete step, which on at least one visible face has printing incorporated into the concrete, wherein only 5% to 90%, preferably 5% to 80%, further preferably 10% to 80%, particularly preferably 20% to 70%, more particularly 30% to 70% of the visible face of the concrete element has printing and the visible face of the concrete element as a result of the printing has a natural stone, wood, textile, tile or mosaic appearance.

It has been found that a concrete element whose visible surface is printed only to an extent of 5% to 90%, on the one hand, can be produced more cost-effectively compared to the prior art. On the other hand, a particularly advantageous natural stone, wood, textile, tile or mosaic appearance can be achieved specifically because the visible face is not completely printed.

According to the invention, it may be the case that the printed visible face of the concrete element has at least one coating covering the printing, preferably at least one lower coating composed of an acrylate dispersion and one upper UV coating, more particularly a varnish.

According to the invention, provision may further be made for printing to have taken place directly onto the concrete element and/or for no primer to be applied to the visible face below the printing.

According to the invention, it may further be the case that at least the visible face of the concrete element is formed by a concrete colored prior to printing and/or by a mixture of different-colored concrete.

According to the invention, it may additionally be the case that the visible face is printed with at least one, preferably two or more, crack lines, more particularly crack lines having a marble appearance, and/or structure lines and/or notches and/or speckles and/or spots and/or shades.

Furthermore, according to the invention, provision may be made for the printing composition to be a printing composition as described above, more particularly a printing composition as defined in the claims, in particular in claims 11 to 16.

With regard to the advantages of the printed concrete element, reference is made analogously to the above statements relating to the method according to the invention.

In the context of the invention, provision may be made in particular for the printing to consist exclusively of crack lines, structure lines, notches, speckles, shades and/or spots.

Features that have been described in connection with one of the subjects of the invention, these being specifically the method according to the invention, the device according to the invention and the printed concrete element according to the invention, can also be implemented advantageously for the other subjects of the invention. Likewise, advantages specified in connection with one of the subjects of the invention can also be understood in relation to the other subjects of the invention.

In addition, it should be noted that expressions such as “comprising”, “having” or “with” do not exclude any other features or steps. Further, expressions such as “a” or “the” that refer in the singular to steps or features do not exclude a plurality of features or steps—and vice versa.

It should be noted that labels such as “first” or “second”, etc. are used predominantly for reasons of distinguishability between respective apparatus or method features and are not necessarily intended to indicate that features require one another or are related to one another.

The invention is described in more detail below on the basis of the drawing and an exemplary embodiment.

The figures each show preferred exemplary embodiments in which individual features of the present invention are illustrated in combination with one another. Features of one exemplary embodiment can also be implemented independently of the other features of the same exemplary embodiment.

Elements of identical function are denoted by the same reference signs in the figures.

### IN THE DRAWINGS

FIG. 1 shows a schematic cross section through a production mold with an illustrative representation of five infilling molds, in each of which a concrete element has formed or is formed, where the concrete element comprises a facing concrete and a core concrete, and with a representation of rams which can be pressed onto one concrete element each from above in order to compact and, where appropriate, to structure said concrete element;

FIG. 2 shows a schematic representation of a concrete element having a visible face which is formed by a top side of the concrete element, where printing is applied to the visible face by means of the method according to the invention; and

FIG. 3 shows a schematic plan view of a visible face of the concrete element that is printed according to the invention and that has a natural stone appearance.

The following exemplary embodiment serves to disclose an advantageous method for producing a printed concrete element 1 and to disclose an advantageous device for producing a printed concrete element 1. Furthermore, the exemplary embodiment serves to disclose an advantageous printed concrete element 1.

A printed concrete element 1 or a concrete element 1 produced according to the method or with the aid of the device is illustrated schematically in FIG. 2.

The method according to the invention and the device according to the invention for producing a printed concrete element 1 are particularly suitable for producing a printed concrete block, more particularly a paving block, a printed concrete slab or a printed concrete step.

Accordingly, the concrete elements 1 represented in the exemplary embodiment are preferably a concrete block, a concrete slab or a concrete step.

The method according to the invention and the device according to the invention provide for at least one visible face 2 of the concrete element 1 to be printed. A visible face 2 of the concrete element 1 is understood in particular to mean a face/side of the concrete element 1 which is visible or completely visible in the laid state of the concrete element 1. Preferably exactly one visible face 2 of the concrete element 2 is printed with the method according to the invention.

In the exemplary embodiment, 5% to 90%, preferably 10% to 80%, more preferably 20% to 70% and particularly preferably 30% to 70% of the visible face 2 of the concrete element 1 are printed in such a way that the visible face 2 has a pattern by means of which the visible face 2 of the concrete element 1 acquires a natural stone, wood, textile, tile or mosaic appearance.

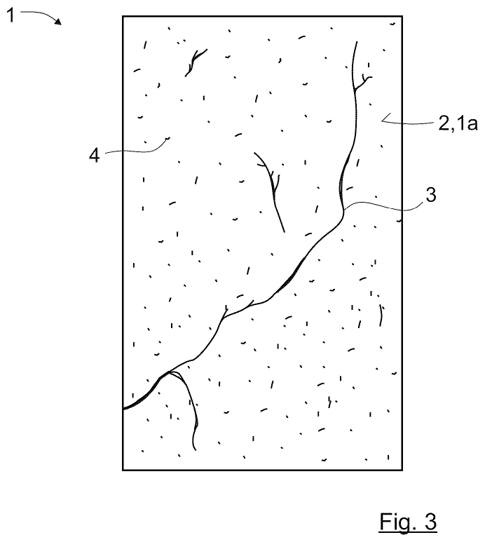

An example of the printing of the visible face 2 in such a way that the visible face 2 acquires a natural stone appearance is illustrated in particular in FIG. 3.

In the exemplary embodiment, provision is made for the visible face 2 to be printed with at least one, preferably two or more, crack lines 3, more particularly crack lines which simulate cracks of a marble stone, and/or structure lines and/or notches 4 and/or speckles and/or spots and/or shades.

The printing with the crack lines 3 and/or the structure lines and/or the notches 4 and/or speckles and/or the spots takes place preferably in such a way that, where appropriate together with further printed im-ages, for example shades, only the aforementioned percentage of the visible face 2 of the concrete element 1 is printed.

After the printing of the visible face 2, provision is made for the concrete element 1 to cure. For the curing, the concrete element 1 can preferably be brought into a curing region, in particular a drying chamber.

In the exemplary embodiment, provision is made for the visible face 2 to constitute a top side 1a of the concrete element 1. The concrete element 1 is preferably cuboidal in form and additionally has a bottom side 1b and side walls 1c running orthogonally thereto.

It should be pointed out that the visible face 2 can also represent a bottom side 1b or one of the side walls 1c. Provision may further be made for a plurality of the sides/walls 1a, 1b, 1c of the concrete elements 1 to be configured as visible faces 2 and to be printed with the method according to the invention.

In the exemplary embodiment, provision is made for at least one region of the visible face 2 of the concrete element 1, in the exemplary embodiment the entire visible face 2 of the concrete element 1, to be colored prior to printing.

The natural color of a concrete used to produce the concrete element 1 is gray. In the exemplary embodiment, it is preferably provided here that at least the concrete which forms the visible face 2 of the concrete element 1 is colored before the printing in such a way that the color of the concrete deviates from the natural color, possibly also only in that a different gray shade is selected, and/or the concrete is designed in such a way that a marbling effect arises, and/or that fine-grained aggregates, composed for example of granite or basalt, are added to the concrete. The concrete can also acquire a structuring and/or a multi-colored design.

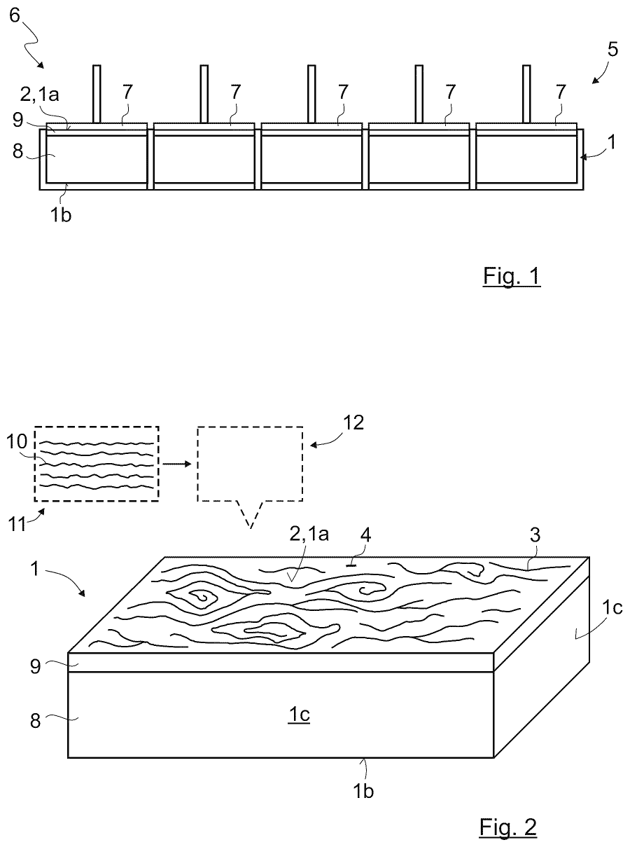

In the exemplary embodiment, provision may be made for a colored concrete and/or a mixture of different-colored concrete to be introduced into an infilling mold 5 for shaping the concrete element 1, in order to produce the concrete element 1. An infilling mold 5 for shaping a concrete element 1 is illustrated schematically in FIG. 1. FIG. 1 shows a production mold 6 for producing a layer of concrete elements 1. Here, in the exemplary embodiment, the production mold 6 has five infilling molds 5 in order to form a corresponding number of concrete elements 1. In the exemplary embodiment, the introduction of the concrete into the infilling mold 5 is followed by vibration and compaction preferably using a ram 7.

FIG. 1 illustrates a particularly advantageous method for producing the concrete element 1. Here it is provided that a so-called core concrete is first introduced into the infilling mold 5 for shaping a main body 8 of the concrete element 1. The core concrete which is used for producing the main body 8 is preferably not colored. After the core concrete has been introduced, in the exemplary embodiment according to FIG. 1, a colored concrete and/or a mixture of different-colored concrete is introduced into the infilling mold 5 in order to shape the visible face 2 of the concrete element 1. This is preferably a so-called facing concrete, which is generally less coarse than the core concrete. The concrete which forms the visible face 2 of the concrete element 1, or the facing concrete, differs in color from the core concrete in that the facing concrete is colored and/or is formed of a mixture of different-colored concrete.

The facing concrete or the concrete forming the visible face 2 is referred to in the exemplary embodiment as facing layer 9. The main body 8 and the facing layer 9 together form the concrete element 1.

For the production of a mixture of different-colored concrete, in the context of the invention, a method for coloring as described in EP 2 237 937 B1 is employed.

As is illustrated schematically in FIG. 1 and in FIG. 2, provision is preferably made for the concrete element 1 to be formed substantially of the main body 8 or the core concrete, preferably at least to an extent of 80%, and for the concrete which forms the visible face 2, i.e. the facing layer 9 composed of the facing concrete, to make up at most 20% of the volume of the concrete element 1.

In order to produce the concrete element 1, it is preferably the case that the core concrete is first introduced into the infilling mold 5. This is followed preferably by vibration and/or intermediate compaction, preferably with the aid of the ram 7. Subsequently, the facing concrete is filled into the infilling mold 5 for forming the facing layer 9. Then vibrating and compacting are preferably repeated, in particular with the aid of the ram 7. Vibration units which are situated below the production mold are preferably used for the purpose of vibration. After the facing concrete has been introduced, the main compaction preferably takes place. Provision may be made for a structuring to be introduced into the visible face 2 of the concrete element 1 with the aid of the ram 7. Provision may further also be made for a chamfer to be introduced circumferentially around the edge of the visible face 2. Subsequently, the concrete element 1 is removed or deshuttered from the infilling mold 5.

The sequence of introduction of the core concrete and the facing concrete can also be reversed, i.e. the facing concrete is introduced first into the infilling mold 5. Furthermore, a facing concrete can be introduced both before and after the core concrete.

The method of the invention for printing the concrete element 1 can be carried out in principle in any state of the concrete element 1, including in particular as a dry printing method. However, it has emerged as being particularly advantageous if the printing of the concrete element 1 is carried out in a green-strength state of the concrete element 1, in which the concrete element 1 is dimensionally stable, but not yet cured.

The concrete element 1 can be printed while the concrete element 1 is still in the infilling mold 5 in which the concrete element 1 is compacted. However, it is advantageous if the concrete element 1 is printed after the concrete element has left the infilling mold 5 in which the concrete element 1 is compacted.

In the exemplary embodiment, provision may be made, in a manner not illustrated, for a coating to be applied after the printing of the visible face of the concrete element, but before the curing. The coating is preferably a coating composed of an acrylate dispersion. The coating is preferably sprayed on. A rolling-on or a curtain coating method may also be suitable for applying the coating.

In the exemplary embodiment, provision may be made (not illustrated) for a coating to be applied, preferably again sprayed on, after the curing, i.e. onto the printed and cured visible face 2 of the concrete element 1. This is preferably a coating which is self-curing or cures with the aid of UV radiation.

It may also be provided here that more than only one coating, for example two coatings, of which preferably one coating is a UV coating, preferably a UV varnish, are applied to the printed and cured visible face 2 of the concrete element 1.

It has emerged as being particularly suitable if, after the printing but before the curing, a coating of acrylate dispersion is applied to the visible face 2 of the concrete element 1 and then, when the concrete element 1 has cured, at least one further coating, in particular a UV coating, is applied to the cured visible face 2 of the concrete element 2.

In the exemplary embodiment, it is the case that the printing of the visible face 2 of the concrete element 1, in particular of a green-strength concrete element 1, takes place with a printing composition 10 substantially consisting of chromophoric inorganic pigments and a preferably binder-free solvent (first configuration) or a preferably binder-free solvent mixture (second configuration). FIG. 2 merely schematically illustrates a reservoir 11 for accommodating the printing composition 10. Furthermore, FIG. 2, likewise merely schematically, illustrates a printer 12, in the exemplary embodiment preferably an inkjet printer, with which the visible face 2 of the concrete element 1 is printed. Printing takes place preferably directly onto the visible face 2 of the concrete element 1, i.e. directly onto the concrete, in particular the facing layer 9.

In the exemplary embodiment, it is also possible (third configuration) to envisage printing with a printing composition 10 which consists substantially of chromophoric inorganic pigments, polyacrylate as binder and a solvent or a solvent mixture.

In the case of the first configuration of the printing composition 10, it is preferably the case that the solvent comprises no siloxane, no silane and no resin, i.e. has a siloxane-free, silane-free and resin-free configuration. The chromophoric pigments here are preferably UV-resistant. Furthermore, in the case of the first configuration, it is the case that the solvent does not have a water fraction or is not an aqueous system. In the case of the first variant, the printing composition 10 may consist preferably of 10% to 90% by weight of the solvent and a corresponding weight percentage fraction of the chromophoric pigments and of any unavoidable residual impurities.

For the second configuration of the printing composition 10, it is preferably the case that the solvent mixture comprises no siloxane, no silane and no resin, i.e. that the solvent mixture is siloxane-free, silane-free and resin-free. For the second configuration of the printing composition 10, it is preferably the case that the chromophoric pigments are UV-resistant. It is further the case for the second variant that the solvent mixture has a water fraction of 10% to 90% by weight. In the context of the printing composition 10, the chromophoric inorganic pigments may make up 20% to 40% by weight, i.e. the printing composition 10 consists to an extent of 20% to 40% by weight of the chromophoric pigments and the solvent mixture has a corresponding weight percentage fraction, and so the printing composition 10 is formed of these two components. In the context of the solvent mixture, the water fraction may be 10% to 90% by weight, preferably 30% to 60% by weight.

In the context of the third configuration of the printing composition 10, for which polyacrylate is used as binder in the context of the printing composition 10, it is possible to use a solvent or a solvent mixture which can be selected as described for the first configuration and the second configuration of the printing composition 10. For the third configuration, it may be the case that the printing composition 10 consists to an extent of 20% to 40% by weight of the chromophoric inorganic pigments.

In the context of the method according to the invention, it is preferably the case that printing is carried out directly onto the visible face 2 of the concrete element 1. In the context of the method according to the invention, provision is made in particular for no primer to be applied to the visible face 2 prior to printing, i.e. the visible face 2 is primer-free.

In the exemplary embodiment (not illustrated), provision may be made for the visible face 2 after the printing, in particular after the curing, to be subjected to a structure-imparting surface treatment, preferably by brushing, embossing, knocking or striking, in particular by shot peening, as is described in EP 1 893 391 B1.

What is claimed is:

1. A method for producing a printed concrete element, more particularly a printed concrete block, a printed concrete slab or a printed concrete step, comprising at least the following steps:
printing at least one visible face of the concrete element; and
curing the concrete element after printing,
wherein 5% to 90% of the visible face of the concrete element is printed in such a way that the visible face has a pattern through which the visible face of the concrete element acquires a natural stone, wood, textile, tile or mosaic appearance.

2. The method as claimed in claim 1, wherein 5% to 80%, of the visible face of the concrete element is printed.

3. The method as claimed in claim 1, wherein the visible face of the concrete element is printed with at least one crack lines having a marble appearance, and/or structure lines and/or notches and/or speckles and/or spots and/or shades.

4. The method as claimed in claim 1, wherein at least one region of the visible face of the concrete element, preferably the entire visible face of the concrete element, is colored prior to printing.

5. The method as claimed in any of claim 1, wherein the visible face of the concrete element prior to printing acquires a marbling appearance and/or a structuring and/or a multi-colored design by virtue of the concrete used for producing the concrete element and/or a color and/or aggregates, more particularly fine-grained aggregates, are added to the concrete used for producing the concrete element.

6. The method as claimed in claim 1, further comprising the following step:
filling a colored concrete and/or a mixture of different-colored concrete into an infilling mold for shaping the concrete element, or
filling a concrete into an infilling mold for shaping a main body of the concrete element and filling a colored concrete and/or a mixture of different-colored concrete into the infilling mold for shaping the visible face of the concrete element, wherein the concrete forming the main body of the concrete element differs in color from the concrete and/or the mixture of different-colored concrete which forms the visible face of the concrete element.

7. The method as claimed in claim 1, wherein the printing of the concrete element is carried out in a green-strength state of the concrete element, in which the concrete element is dimensionally stable but not yet cured.

8. The method as claimed in claim 1, wherein the concrete element is printed while the concrete element is still in an infilling mold in which the concrete element is compacted, or the concrete element is printed after the concrete element has left an infilling mold in which the concrete element is compacted.

9. The method as claimed in claim 1, further comprising the following step:
applying, preferably spraying, at least one coating, preferably composed of an acrylate dispersion, to the printed visible face of the concrete element before curing.

10. The method as claimed in any of claim 1,
applying, preferably spraying, at least one coating, preferably a UV coating, more particularly a varnish, to the printed and cured visible face of the concrete element.

11. The method as claimed in any of claim 1, wherein the printing takes place with a printing composition 1, substantially consisting of chromophoric inorganic pigments and a solvent, preferably a binder-free solvent, or a solvent mixture, preferably a binder-free solvent mixture.

12. The method as claimed in claim 1, wherein the printing takes place with a printing composition, substantially consisting of chromophoric inorganic pigments, polyacrylate as binder and a solvent or a solvent mixture.

13. The method as claimed in claim 11, wherein:
a) the solvent is siloxane-free and/or silane-free and/or resin-free, and/or
b) the chromophoric pigments are UV-resistant, and/or
c) the solvent has no water fraction or is not an aqueous system, and/or
d) the printing composition consists of 10% to 90% by weight of the solvent and the chromophoric pigments.

14. The method as claimed in claim 11, wherein:
a) the solvent mixture is siloxane-free and/or silane-free and/or resin-free, and/or
b) the chromophoric pigments are UV-resistant, and/or
c) the solvent mixture has a water fraction of 10% to 90% by weight.

15. The method as claimed in claim 1, wherein the printing takes place directly on the concrete element and/or no coating and/or no primer is applied to the visible face prior to printing.

16. The method as claimed in claim 1, wherein the printing takes place using an inkjet printing, screen printing, powder coating, laser printing, needle printing, electrostatic printing, liquid printing, digital printing and/or pad printing method.

17. A device for producing a printed concrete element, more particularly a printed concrete block, a printed concrete slab or a printed concrete step, having a reservoir for accommodating a printing composition for printing the concrete element and having a printer for printing at least one visible face of the concrete element, wherein the printer is designed and configured to print a green-strength concrete element in accordance with a method as claimed in claim 1.

18. A printed concrete element, more particularly printed concrete block, printed concrete slab or printed concrete step, obtainable by a method as claimed in claim 1.

19. A printed concrete element, more particularly a printed concrete block, a printed concrete slab or a printed concrete step, which on at least one visible face has printing incorporated into the concrete, wherein only 5% to 90%, of the visible face of the concrete element has printing and the visible face of the concrete element as a result of the printing has a natural stone, wood, textile, tile or mosaic appearance.

20. The printed concrete element as claimed in claim 19, wherein the printed visible face of the concrete element has at least one coating covering the printing, preferably at least one lower coating composed of an acrylate dispersion and one upper UV coating, more particularly a UV varnish.

21. The printed concrete element as claimed in claim 19, wherein the printing has taken place directly onto the concrete element and/or no primer has been applied to the visible face below the printing.

22. The printed concrete element as claimed in claim 19, characterized in that wherein at least the visible face of the concrete element is formed by a concrete colored prior to printing and/or by a mixture of different-colored concrete.

23. The printed concrete element as claimed in claim 19, wherein the visible face is printed with at least one crack lines having a marble appearance, and/or structure lines and/or notches and/or speckles and/or spots and/or shades.

24. The printed concrete element as claimed in claim 19, wherein the printing composition substantially consists of chromophoric inorganic pigments and a solvent, preferably a binder-free solvent, or a solvent mixture, preferably a binder-free solvent mixture.
